(19) United States
(12) Patent Application Publication
(10) Pub. No.: US 2016/0100160 A1
(43) Pub. Date: Apr. 7, 2016

(54) BLURRY IMAGE DETECTING METHOD AND RELATED CAMERA AND IMAGE PROCESSING SYSTEM

(71) Applicant: Vivotek Inc., New Taipei City (TW)

(72) Inventor: Yi-Chen Tsai, New Taipei City (TW)

(21) Appl. No.: 14/836,977

(22) Filed: Aug. 27, 2015

(30) Foreign Application Priority Data
Oct. 2, 2014 (TW) 103134442

(51) Int. Cl. H04N 17/00; G06K 9/00; G06K 9/66; H04N 5/232

(52) U.S. Cl. CPC H04N 17/002; H04N 5/23212; G06K 9/00771; G06K 9/66

(57) ABSTRACT

A blurry image detecting method and related camera and image processing system are provided. The blurry image detecting method includes capturing an image stream, comparing a first gradient magnitude difference between the (N−M)th image and the Nth image with a threshold, calculating a first accumulative quantity of the images with the first gradient magnitude difference greater than the threshold, and determining the Nth image is the blurry image according to a comparison result of the first gradient magnitude difference and a calculation result of the first accumulative quantity. Numeral “N” and numeral “M” respectively are positive integers, and numeral “N” is greater than numeral “M”.

### BACKGROUND OF THE INVENTION

1. Field of the Invention

The present invention relates to a camera, and more particularly, to a camera with blurry image detecting function and a related image processing system and a related blurry image detecting method.

2. Description of the Prior Art

The monitoring camera has widespread applications and can be installed on an entrance of building, such as a factory, a dormitory, a store, a building and a residence house, or on a road where few people tread. The monitoring camera can record and store surrounding image to prevent criminal evidence from missing for someday investigation or verification.

The monitoring camera is occasionally destroyed by the suspect to remove the evidence, such as sheltering lens of the camera so the monitoring camera cannot capture images, or adjusting lens focus of the camera to generate unclear images. Besides, definition of the monitoring camera may be gradually decreased and lose optimal efficiency due to environmental variation or functional spoilage, and the technician manually repairs failure of the monitoring camera to recover the definition of the monitoring camera while the failure is inspected by the manager in a remote controlling manner. That is, design of a method capable of automatically and rapidly distinguishing the blurry image of the monitoring camera by any factors to overcome inconvenience of manual adjustment of the monitoring camera is an important issue in the related industry.

### SUMMARY OF THE INVENTION

The present invention provides a camera with blurry image detecting function and a related image processing system and a related blurry image detecting method for solving above drawbacks.

According to the claimed invention, a blurry image detecting method includes capturing an image stream, comparing a first gradient magnitude difference between a (N−M)th image and a Nth image of the image stream with a threshold, calculating a first accumulative quantity of the first gradient magnitude difference greater than the threshold, and determining whether the Nth image is the blurry image according to a comparison result of the first gradient magnitude difference and a calculation result of the first accumulative quantity. Numerals “N” and “M” are positive integers, and the numeral “N” is greater than the numeral “M”.

According to the claimed invention, a camera with blurry image detecting function includes an image sensor and a processing unit. The image sensor is adapted to capture an image stream. The processing unit is electrically connected to the image sensor and adapted to execute the above-mentioned blurry image detecting method.

According to the claimed invention, an image processing system is applied to determine whether at least one image stream transmitted from at least one camera has a blurry image, and adapted to execute the above-mentioned blurry image detecting method.

The camera with blurry image detecting function and the related image processing system and the related blurry image detecting method of the present invention utilizes the gradient magnitude of the image to determine whether the designated image belongs to the blurry image; for example, the image is sharp and clear when the gradient magnitude is higher, and the image is defocused and blurry when the gradient magnitude is lower. Thus, the blurry image detecting method can establish learning information (which is generated according to the gradient magnitude of the image) while the system is activated for the blurry image detection. The blurry image detecting method may generate the warning while detecting the blurry image, focus of the camera is adjusted automatically or manually, and the system is triggered to update the learning information. Comparing to the prior art, the blurry image detecting method of the present invention can analyze any blurry possibility of the camera, such as defocusing phenomenon within wide range by rapid adjustment, defocusing phenomenon by slight slow adjustment, and defocusing phenomenon by continued adjustment, so as to effectively prevent the blurry image from generating even though the camera is sheltered or interfered due to human factor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image processing system according to an embodiment of the present invention.

FIG. 2 is a flow chart of the blurry image detecting method according to the embodiment of the present invention.

FIG. 3 is a flow chart of the learning algorithm started while detecting the blurry image according to the embodiment of the present invention.

### DETAILED DESCRIPTION

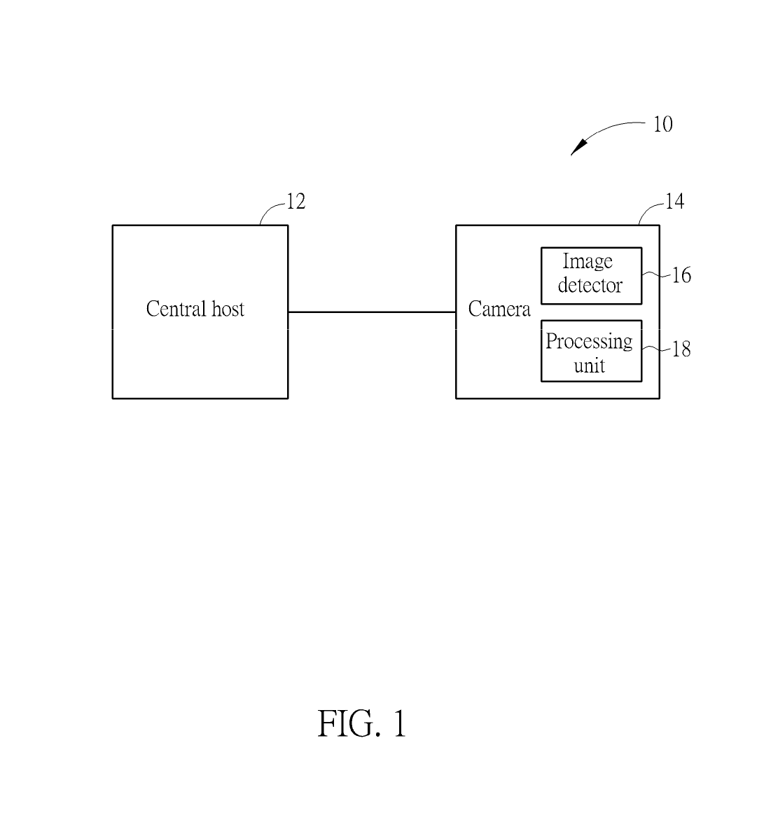

Please refer to FIG. 1. FIG. 1 is a functional block diagram of an image processing system 10 according to an embodiment of the present invention. The image processing system 10 includes a central host 12 and a camera 14, and the camera 14 includes an image sensor 16 and a processing unit 18 electrically connected with each other. The image sensor 16 is adapted to detect a specific monitoring area and to capture an image stream composed of monitoring images accordingly. The processing unit 18 is adapted to execute a blurry image detecting method. Further, the central host 12 can receive the image stream transmitted from the camera 14 in a wire transmission or in a wireless transmission, determine whether the image stream from the camera 14 has the blurry image according to a detection result so as to decide whether a learning algorithm is started to execute an autofocusing procedure, and the image processing system 10 and/or the camera 14 can voluntarily eliminate or repair the blurry image while the image sensor 16 is sheltered or out of focus. For example, the camera 14 may utilize the built-in processing unit 18 to execute the blurry image detecting method and voluntarily determine whether the image captured by the camera 14 is the blurry image; in another embodiment, the camera 14 can transmit the captured image stream to the external central host 12, and the central host 12 executes the blurry image detecting method to determine whether the image captured by the camera 14 is the blurry image. An amount of the camera 14 is not limited by the embodiment shown in FIG. 1, which means the image processing system 10 may include a plurality of cameras 14 and depends on actual demand.

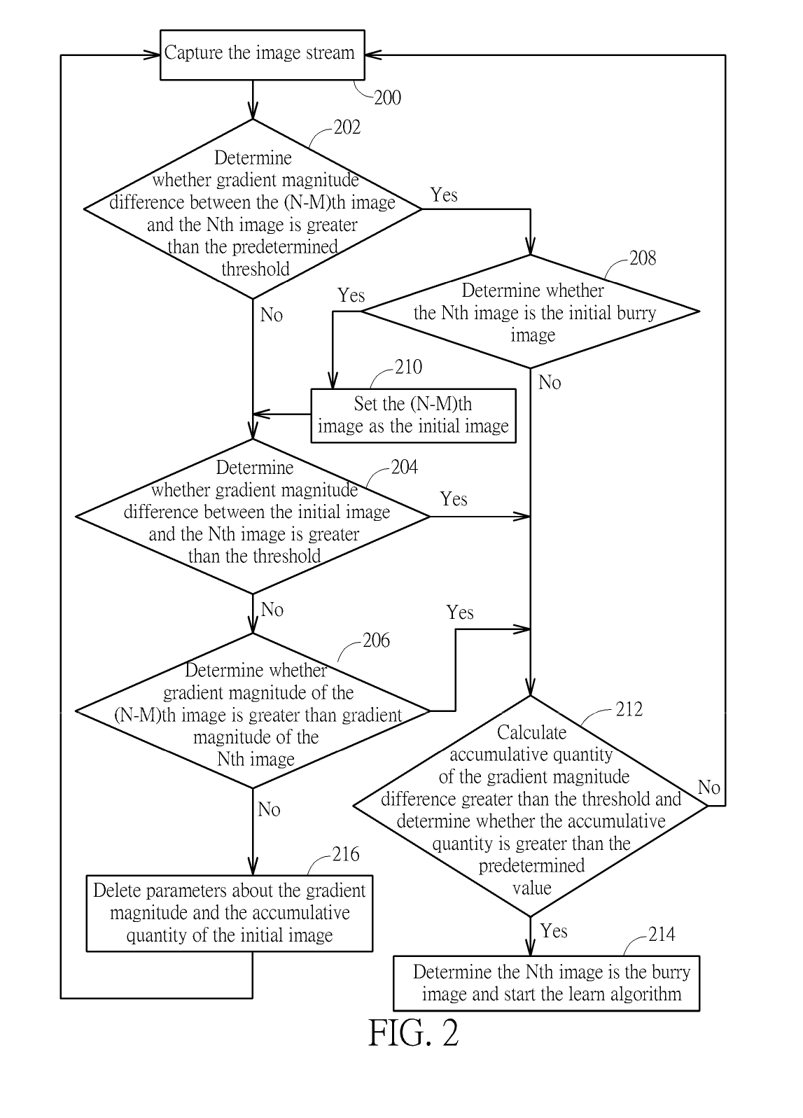

Please refer to FIG. 2. FIG. 2 is a flow chart of the blurry image detecting method according to the embodiment of the present invention. The blurry image detecting method illustrated in FIG. 2 is suitable for the image processing system 10 and the camera 14 shown in FIG. 1. First, step 200 is executed that the blurry image detecting method utilizes the image sensor 16 to capture the image stream. The image stream preferably includes, but not limited to, a plurality of sequential images with time correlation. Then, the blurry image detecting method compares gradient magnitude of a series of images with each other. For example, step 202 is executed to compare a first gradient magnitude difference between an (N−M)th image and an Nth image of the image stream with a predetermined threshold, step 204 is executed to compare a second gradient magnitude difference between an initial image and the Nth image of the image stream with the predetermined threshold, and step 206 is executed to compare a gradient magnitude of the (N−M)th image with a gradient magnitude of the Nth image. Generally, step 202 and step 204 are executed in foresaid sequence, and the thresholds used in step 202 and step 204 are identical. Executing sequence of step 206 is not limited to the above-mentioned embodiment, which means step 206 may be executed between step 200 and step 202. Further, the numerals “N” and “M” are positive integers, and the numeral “N” is greater the numeral “M”. As the numeral “N” is equal to 6 and the numeral “M” is equal to 1, the image stream includes six images, and each image compares its gradient magnitude with the gradient magnitude of the former image; for example, the sixth image is compared with the fifth image, and the fifth image is compared with the fourth image. In another embodiment, the numeral “N” can be equal to 6 and the numeral “M” can be equal to 2, the sixth image is compared with the fourth image, and the fourth image is compared with the second image. The numerals of N, M are not limited to the above-mentioned embodiments and can be set according to user's demand.

Step 202 is applied to overcome a situation that the defocused image is resulted by wide adjustment of the camera 14. While the first gradient magnitude difference is smaller than the threshold, the Nth image is not determined as the blurry image, and step 204 is executed to overcome the situation that the defocused image is resulted by slight adjustment of the camera 14. For example, the image captured by the camera 14 does not conform to condition of the blurry image though the camera 14 is adjusted in step 202, the camera 14 may be continuously adjusted in step 204 to be set in a defocused state or may be not adjusted in step 204, and the camera 14 can be kept in the defocused state similar to ones in step 202 so that the image is determined as the blurry image by step 204. While the first gradient magnitude difference is greater than the threshold, step 208 is executed to determine whether the Nth image is the initial blurry image of the image stream. Since the Nth image is the initial blurry image, step 210 is executed to set the (N−M)th image as the initial image of the image stream and then step 204 is executed accordingly. Since the Nth image is not the initial blurry image, step 212 is executed to calculate a first accumulative quantity of the first gradient magnitude difference greater than the threshold, and further to compare the first accumulative quantity with the first predetermined value. The accumulative quantity represents a quantity sum of the images having characteristic of the gradient magnitude difference being greater than the threshold, or can be defined as a producing period sum of the image having the characteristic of the gradient magnitude difference being greater than the threshold so as to calculate continuous duration of the foresaid characteristic (the gradient magnitude difference being greater than the threshold). While the first accumulative quantity is lower than the first predetermined value, the Nth image is not determined as the blurry image, step 200 can be executed for next blurry image determination. The foresaid characteristic (the gradient magnitude difference being greater than the threshold) is continued for a while as the first accumulative quantity is higher than the first predetermined value; in the meantime, the image is determined as the blurry image, and step 214 is executed to start the learn algorithm accordingly.

The initial image (which is acquired by step 210) illustrated in step 204 is the clearest image of the image stream while the focus of the camera 14 is violently varied. In step 204, the Nth image is not determined as the blurry image while the second gradient magnitude difference is smaller than the threshold, and step 206 is executed to actuate the next blurry image determination. While the second gradient magnitude difference is greater than the threshold, step 212 is executed to calculate the second accumulative quantity of the second gradient magnitude difference greater than the threshold, and further to compare the second accumulative quantity with the threshold. Then, step 214 can be executed to determine whether the Nth image is the blurry image according to a comparison result of the second gradient magnitude difference with the threshold, and/or according to a calculation result of the second accumulative quantity and/or the first accumulative quantity. For example, while the second gradient magnitude difference is greater than the threshold, and the second accumulative quantity is higher than the second predetermined value or a sum of the first accumulative quantity and the second accumulative quantity is higher than a third predetermined value, the Nth image is determined as the blurry image and the learning algorithm is started by step 214. While the second accumulative quantity is lower than the second predetermined value or the sum of the first accumulative quantity and the second accumulative quantity is lower than the third predetermined value, step 200 is executed for the next blurry image determination. The third predetermined value is preferably smaller than a sum of the first predetermined value and the second predetermined value.

Step 206 is applied to overcome a situation that the defocused image is resulted by continuous focus adjustment of the camera 14. For example, because of a slight adjustment of the camera 14, conditions of the camera 14 do not conform to the blurry image determination in step 202 and step 204 though the camera 14 is continuously adjusted, and the image captured by the camera 14 is determined as the blurry image in step 206. While the gradient magnitude of the (N−M)th image is smaller than the gradient magnitude of the Nth image, the image stream has not blurry image, the learn algorithm is not started, step 216 is executed to delete related parameters about the gradient magnitude, the first accumulative quantity, the second accumulative quantity and the third accumulative quantity of the initial image, and step 200 is executed again for the next blurry image determination. While, the gradient magnitude of the (N−M)th image is greater than the gradient magnitude of the Nth image, step 212 is executed to calculate the third accumulative quantity having a characteristic of the gradient magnitude of the (N−M)th image greater than the gradient magnitude of the Nth image. The third accumulative quantity can be the quantity sum or the continuous duration of the foresaid characteristic. While the gradient magnitude of the (N−M)th image is greater than the gradient magnitude of the Nth image, and the third accumulative quantity is higher than the fourth predetermined value, or a sum of the first accumulative quantity, the second accumulative quantity and the third accumulative quantity is higher than the first predetermined value, the second predetermined value and the third predetermined value, the Nth image can be determined as the blurry image and the learning algorithm is started accordingly in step 214. While the third accumulative quantity is lower than the fourth predetermined value, or the sum of the first accumulative quantity, the second accumulative quantity and the third accumulative quantity is lower than the first predetermined value, the second predetermined value and the third predetermined value, step 200 is executed for the next blurry image determination. The fourth predetermined value is smaller than a sum of the first predetermined value, the second predetermined value and the third predetermined value.

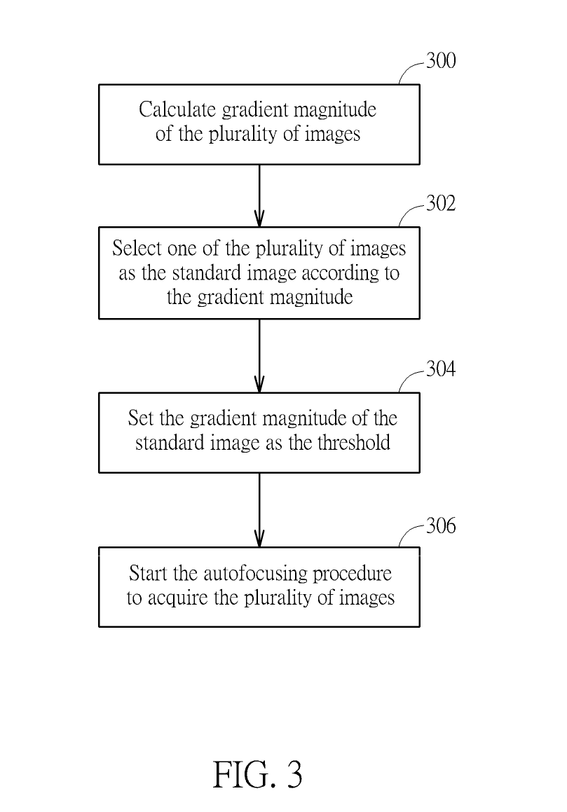

Please refer to FIG. 3. FIG. 3 is a flow chart of the learning algorithm which is started while detecting the blurry image according to the embodiment of the present invention. The learning algorithm illustrated in FIG. 3 is suitable for the image processing system 10 and the camera 14 shown in FIG. 1 and the blurry image detecting method illustrated in FIG. 2. First, step 300 and step 302 are executed to calculate the gradient magnitude of the plurality of images to determine whether the learning algorithm is continued. The blurry image detecting method is actuated while the learning algorithm is not executed, and one of the plurality of images is selected as a standard image according to those gradient magnitudes while the learning algorithm is continued. For example, the learning algorithm acquires six continuous images from the image stream, the six continuous images are arranged in sequence according to those gradient magnitude, and a mean of the six continuous images (such like the third image or the fourth image) is selected to be the standard image; the median of the six continuous images is set as the standard image since the amount of the continuous images is odd numbers. An amount of the continuous images is not limited to the odd numbers or even numbers, which depends on design demand. In addition, the learning algorithm further can optionally acquire the standard image from the plurality of continuous images according to the mean gradient magnitude, the weighted gradient magnitude or the maximum gradient magnitude.

The blurry image detecting method can prompt a warning and start the learning algorithm while the blurry image is detected, and replace the original standard image by a new standard image via the learning algorithm. Therefore, the gradient magnitude of the standard image can be set as the threshold in step 304 for application of the blurry image detecting method illustrated in step 202 and step 204. While the blurry image detecting method determines the captured image being the blurry image, the learning algorithm can start the autofocusing procedure by step 306, to drive automatic adjustment of the camera 14 and the image processing system 10 for amendment of the defocused image. The camera 14 and the image processing system 10 may still execute the foresaid blurry image detecting method, the learning algorithm and the autofocusing procedure while the image is adjusted for the optimal definition by automatic focus adjustment or manual focus adjustment, so as to ensure that the image stream is wholly composed of clear images.

In conclusion, the camera with blurry image detecting function and the related image processing system and the related blurry image detecting method of the present invention utilizes the gradient magnitude of the image to determine whether the designated image belongs to the blurry image; for example, the image is sharp and clear when the gradient magnitude is higher, and the image is defocused and blurry when the gradient magnitude is lower. Thus, the blurry image detecting method can establish learning information (which is generated according to the gradient magnitude of the image) while the system is activated for the blurry image detection. The blurry image detecting method may generate the warning alarm while detecting the blurry image, focus of the camera is adjusted automatically or manually, and the system is triggered to update the learning information. Comparing to the prior art, the blurry image detecting method of the present invention can analyze any blurry possibility of the images captured by the camera, such as defocusing phenomenon within wide range by rapid adjustment, defocusing phenomenon by slight slow adjustment, and defocusing phenomenon by continued adjustment, so as to effectively prevent the blurry image from generating even though the camera is sheltered or interfered due to human factor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A blurry image detecting method comprising:
capturing an image stream;
comparing a first gradient magnitude difference between a (N−M)th image and a Nth image of the image stream with a threshold, wherein N and M are positive integers and N is greater than M;
calculating a first accumulative quantity of the first gradient magnitude difference greater than the threshold; and
determining whether the Nth image is the blurry image according to a comparison result of the first gradient magnitude difference and a calculation result of the first accumulative quantity.

2. The blurry image detecting method of claim 1, wherein the first accumulative quantity represents a quantity sum of the first gradient magnitude difference greater than the threshold, or a producing period sum of the first gradient magnitude difference greater than the threshold.

3. The blurry image detecting method of claim 1, wherein the Nth images is determined as the blurry image and a learning algorithm is started while the first gradient magnitude difference is greater than the threshold and the first accumulative quantity is higher than a first predetermined value.

4. The blurry image detecting method of claim 3, further comprising:
setting the (N−M)th image as an initial image of the image stream while the Nth image is determined as an initial blurry image of the image stream.

5. The blurry image detecting method of claim 3, further comprising:
comparing a second gradient magnitude difference between the initial image and the Nth image of the image stream with the threshold;
calculating a second accumulative quantity of the second gradient magnitude difference greater than the threshold; and
determining whether the Nth image is the blurry image according to a comparison result of the second gradient magnitude difference and calculation results of the second accumulative quantity and/or the first accumulative quantity.

6. The blurry image detecting method of claim 5, wherein the Nth images is determined as the blurry image and the learning algorithm is started while the second gradient magnitude difference is greater than the threshold and the second accumulative quantity is higher than a second predetermined value or a sum of the first accumulative quantity and the second accumulative quantity is higher than a third predetermined value, the third predetermined value is smaller than a sum of the first predetermined value and the second predetermined value.

7. The blurry image detecting method of claim 5, further comprising:
comparing gradient magnitude of the (N−M)th image with gradient magnitude of the Nth image;
calculating a third accumulative quantity of the gradient magnitude of the (N−M)th image greater than the gradient magnitude of the Nth image; and
determining whether the Nth image is the blurry image according to a comparison result of the gradient magnitude and a calculation result of the second accumulative quantity and the third accumulative quantity and/or the first accumulative quantity.

8. The blurry image detecting method of claim 7, wherein the Nth image is determined as the blurry image and the learning algorithm is started while the gradient magnitude of the (N−M)th image is greater than the gradient magnitude of the Nth image and the third accumulative quantity is higher than a fourth predetermined value or a sum of the first accumulative quantity, the second accumulative quantity and the third accumulative quantity is higher than the first predetermined value, the second predetermined value and the third predetermined value, the fourth predetermined value is smaller than a sum of the first predetermined value, the second predetermined value and the third predetermined value.

9. The blurry image detecting method of claim 7, wherein the learning algorithm is not started and parameters of the first accumulative quantity, the second accumulative quantity and the third accumulative quantity are deleted while the gradient magnitude of the (N−M)th image is smaller than the gradient magnitude of the Nth image, or at least one of the first accumulative quantity, the second accumulative quantity and the third accumulative quantity or a sum of the first accumulative quantity, the second accumulative quantity and the third accumulative quantity is lower than one of the first predetermined value, the second predetermined value and a fourth predetermined value accordingly.

10. The blurry image detecting method of claim 1, wherein a learning algorithm is started while the Nth image is determined as the blurry image, the learning algorithm comprises:
calculating gradient magnitude of a plurality of images;
selecting one of the plurality of images to be a standard image according to the gradient magnitude; and
setting the gradient magnitude of the standard image as the threshold.

11. The blurry image detecting method of claim 10, wherein the learning algorithm further comprises:
acquiring the plurality of images while an autofocusing procedure is started.

12. The blurry image detecting method of claim 10, wherein a step of selecting one of the plurality of images to be the standard image according to the gradient magnitude comprises:
arranging the plurality of images according to degree of the gradient magnitude; and
selecting a mean of the plurality of arranged images to be the standard image.

13. A camera with blurry image detecting function, the camera comprising:
an image sensor adapted to capture an image stream; and
a processing unit electrically connected to the image sensor and adapted to compare a first gradient magnitude difference between a (N−M)th image and a Nth image of the image stream with a threshold, wherein N and M are positive integers and N is greater than M, to calculate a first accumulative quantity of the first gradient magnitude difference greater than the threshold, and to determine whether the Nth image is the blurry image according to a comparison result of the first gradient magnitude difference and a calculation result of the first accumulative quantity.

14. The camera with blurry image detecting function of claim 13 wherein the first accumulative quantity represents a quantity sum of the first gradient magnitude difference greater than the threshold, or a producing period sum of the first gradient magnitude difference greater than the threshold.

15. The camera with blurry image detecting function of claim 13, wherein the Nth images is determined as the blurry image and a learning algorithm is started while the first gradient magnitude difference is greater than the threshold and the first accumulative quantity is higher than a first predetermined value.

16. The camera with blurry image detecting function of claim 13, wherein the processing unit further executes a learning algorithm while the Nth image is determined as the blurry image, the learning algorithm comprises:
calculating gradient magnitude of a plurality of images;
selecting one of the plurality of images to be a standard image according to the gradient magnitude; and
setting the gradient magnitude of the standard image as the threshold.

17. An image processing system applied to determine whether at least one image stream transmitted from at least one camera has a blurry image, and adapted to capture an image stream, to compare a first gradient magnitude difference between a (N−M)th image and a Nth image of the image stream with a threshold, wherein N and M are positive integers and N is greater than M, to calculate a first accumulative quantity of the first gradient magnitude difference greater than the threshold, and to determine whether the Nth image is the blurry image according to a comparison result of the first gradient magnitude difference and a calculation result of the first accumulative quantity.

18. The image processing system of claim 17, wherein the first accumulative quantity represents a quantity sum of the first gradient magnitude difference greater than the threshold, or a producing period sum of the first gradient magnitude difference greater than the threshold.

19. The image processing system of claim 17, wherein the Nth images is determined as the blurry image and a learning algorithm is started while the first gradient magnitude difference is greater than the threshold and the first accumulative quantity is higher than a first predetermined value.

20. The image processing system of claim 17, wherein the image processing system further executes a learning algorithm while the Nth image is determined as the blurry image, the learning algorithm comprises:
calculating gradient magnitude of a plurality of images;
selecting one of the plurality of images to be a standard image according to the gradient magnitude; and
setting the gradient magnitude of the standard image as the threshold.
